(19) United States
(12) Patent Application Publication
(10) Pub. No.: US 2011/0308383 A1
(43) Pub. Date: Dec. 22, 2011

(54) PISTON ACCUMULATOR

(75) Inventor: Thorsten Hillesheim, Remgen (DE)

(73) Assignee: CARL FREUDENBERG KG, Weinheim (DE)

(21) Appl. No.: 13/153,532

(22) Filed: Jun. 6, 2011

(30) Foreign Application Priority Data
Jun. 17, 2010 (DE) 10 2010 024 126.1

(51) Int. Cl. F16J 9/00

(52) U.S. Cl. 92/248

(57) ABSTRACT

A piston accumulator includes a housing having a housing wall and a piston disposed in the housing. The housing wall and the piston form a pressure chamber. The piston is slidably moveable along the housing wall so as to change a volume of the pressure chamber. A slide layer disposed on at least one of the piston and the housing wall is configured to guide the piston free of guide rings.

### CROSS-REFERENCE TO PRIOR APPLICATIONS

Priority is claimed to German Patent Application No. DE 10 2010 024 126.1-14, filed on Jun. 17, 2010, the entire disclosure of which is hereby incorporated by reference herein.

### FIELD

The present invention relates to a piston accumulator.

### BACKGROUND

Piston accumulators, which are known at the present time and are used in accumulator technology, have a piston made of aluminum or steel. This piston is used for media separation. In this connection, gases of the pressure chamber are separated from hydraulic fluids.

The final contour of the known pistons is produced in a machining process. The known pistons exhibit a clearance with the housing surrounding them.

The support and guidance of the known pistons are ensured by what are generally referred to as guide rings. These guide rings are made of polytetraflourethylene having a graphite intercalation. These guide rings are relatively expensive and must be specially installed.

Moreover, at present, what is generally referred to as a supporting ring is installed to protect an elastomer sealing ring against extrusion.

Therefore, the known piston accumulators are relatively expensive and entail a complex manufacturing.

### SUMMARY

In an embodiment, the present invention provides a piston accumulator including a housing having a housing wall and a piston disposed in the housing. The housing wall and the piston form a pressure chamber. The piston is slidably moveable along the housing wall so as to change a volume of the pressure chamber. A slide layer disposed on at least one of the piston and the housing wall is configured to guide the piston free of guide rings.

### BRIEF DESCRIPTION OF THE DRAWINGS

The present invention will be described in even greater detail below based on the exemplary figures, which are not to scale. The invention is not limited to the exemplary embodiments. Other features and advantages of various embodiments of the present invention will become apparent by reading the following detailed description with reference to the attached drawings which illustrate the following:

FIG. 1 shows, in a sectional view, a piston accumulator according to the present invention having a piston, without guide rings and without supporting rings for the seal; and

FIG. 2 shows, in a sectional view, a piston accumulator of the prior art, where the piston is provided with a supporting ring for the seal and with two guide rings.

### DETAILED DESCRIPTION

It is an aspect of the present invention to provide a piston accumulator whose piston may be easily manufactured and installed.

In an embodiment, the present invention provides a piston accumulator including a housing having a pressure chamber that is bounded by a housing wall and a piston, the piston being movable relative to the housing, the volume of the pressure chamber being variable, and the piston being slidingly displaceable along the housing wall.

According to an embodiment, the piston accumulator includes a slide layer that is assigned to the piston and/or to the housing wall in a way that allows the piston to move along the housing wall while being free of guide rings.

In accordance with an embodiment of the present invention, it has been recognized that a slide layer allows a piston to travel without guide rings within a housing. In this context, it has been specifically recognized that the action of a slide layer makes it possible to adjust the clearance between the outer surface of the piston and the housing wall in a way that eliminates the need for guide rings. Therefore, the piston accumulator according to an embodiment of the present invention does not have any guide rings assigned to the piston. Thus, the need for installing guide rings is eliminated. Since the piston accumulator according to the embodiment does not have any guide rings, its installation is considerably simplified. Thus, the piston accumulator can be manufactured cost-effectively and without difficulty.

A slide layer may be formed on the piston. This enables the piston to be easily equipped with a slide layer and installed in a housing having predefined dimensions.

Against this background, a slide layer may be formed on the housing wall. A slide layer on the housing wall makes it possible to compensate for manufacturing tolerances during the fabrication thereof.

In this context, it is specifically conceivable for a slide layer to be formed either only on the piston or only on the housing wall or on the piston and on the housing wall.

A seal without a supporting ring may be mounted on the piston. A sealing ring of an elastomer that surrounds the piston is preferably used as a seal. By properly selecting the clearance between the outer surface of the piston and the housing wall, an extrusion of the sealing ring is counteracted in such a way that there is no further need for a ring.

The piston may be fabricated of plastic. A piston of plastic is able to be manufactured using what is generally referred to as an off-tool process. Moreover, a piston made of plastic may be fabricated using a plastic injection mold. In this context, the manufacturing may be implemented in such a way that the piston already exhibits its final dimensions, respectively, its final contour and is installable without further machining Manufacturing the piston out of plastic makes it possible, in particular, for a clearance to be adjusted between the piston and the housing wall in a way that eliminates the need for a supporting ring. Therefore, the piston accumulator does not have any supporting ring assigned to the piston. The need for installing the supporting ring is eliminated. In addition, the need for installing guide rings is eliminated. Therefore, the piston accumulator does not have any guide rings assigned to the piston.

Against this background, the slide layer may be formed in one piece and integrally with the piston, namely as an outer surface of the piston. The low friction properties of the plastic that is used are hereby utilized without providing a slide layer that is structurally or constructionally separate from the piston. The slide layer is quasi integrated in the plastic and determined by the material properties thereof.

The piston may be fabricated of a thermoset plastic. Tribological requirements and the permeation values for the gas within the piston accumulator determine the selection of the plastic. Surprisingly, thermoset plastics have proven to be especially impermeable to gases.

The piston may be fabricated of a thermoplastic plastic. In terms of form design and shaping, thermoplastics are readily processable.

The piston may be fabricated of aluminum and be manufactured using a shaping process, in particular, a cold extrusion process. The piston may be fabricated of a metal, preferably an aluminum material. In this case, the clearances between the piston and the housing wall are adapted in a way that makes it possible to eliminate the need for guide rings and/or supporting rings. The tribological properties are optimized in that a slide layer is produced by a surface coating process. The slide layer may be applied to the piston and/or to the housing wall. The initial contour of the piston may be produced by a cold extrusion process, the final contour being created by a machine-cutting process.

The housing may be fabricated of plastic. This makes it possible to save costs and economize on weight.

In particular, the housing may be fabricated of a thermoset plastic. A high gas tightness is realized in this manner.

The housing may also be fabricated of a thermoplastic plastic. Given suitable thermal conditions, these plastics are readily processable in terms of form design.

The housing may also be fabricated of steel, aluminum or a plastic. The material is selected as a function of its thermal expansion coefficients. Aluminum is advantageously quickly machinable and does not require any rolling process to achieve gas tightness in the context of dynamic sealing using suitable methods. These process improvements make it possible for the housing to be produced cost-effectively.

The piston accumulator described here may be advantageously used everywhere stored hydraulic energy is needed. In particular, the piston accumulator may be used in hydraulic systems of motor vehicles or industrial hydraulic systems.

The present invention may be advantageously embodied and refined in various ways. In this regard, reference is made to the following description of a preferred exemplary embodiment of the piston accumulator according to the present invention which makes reference to the drawing.

In conjunction with the explanation of the preferred exemplary embodiment with reference to the drawing, an explanation is also given of generally preferred embodiments and refinements of the teaching.

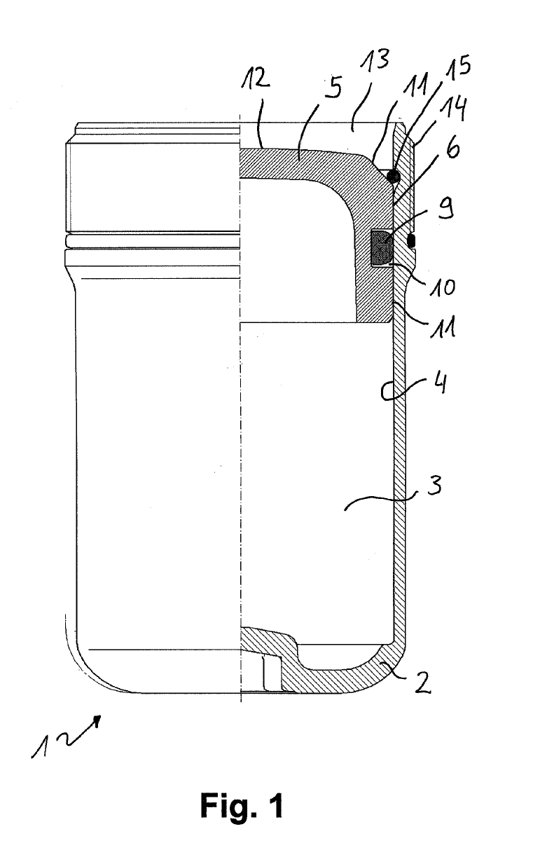

FIG. 1 shows a piston accumulator 1, encompassing a housing 2 having a pressure chamber 3, which is bounded by housing wall 4 and a piston 5, piston 5 being movable relative to housing 2, the volume of pressure chamber 3 being variable, and piston 5 being slidingly displaceable along housing wall 4.

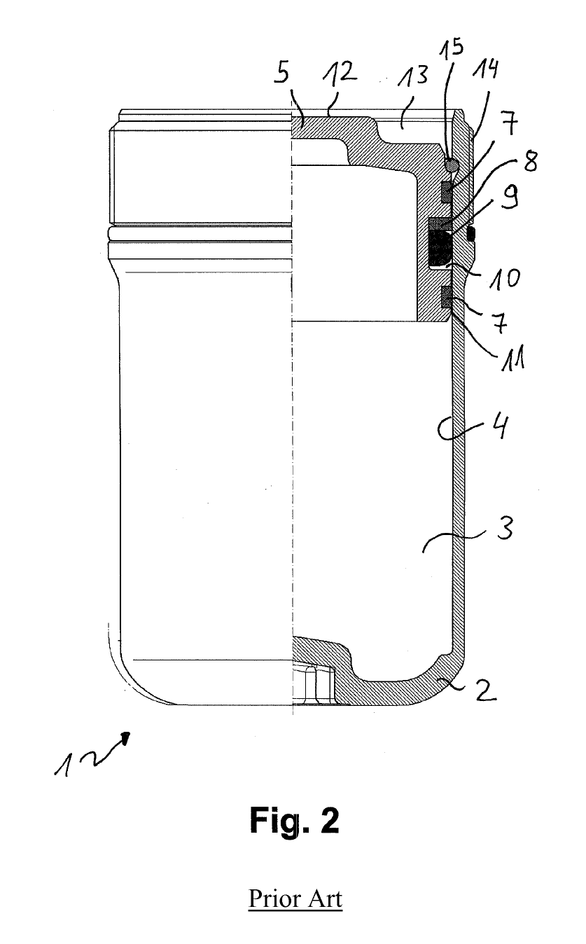

A slide layer 6 is assigned to piston 5 in such a way that piston 5 is movable along housing wall 4 while being free of guide rings. Piston 5 does not have any guide rings 7 (see FIG. 2).

On the other hand, a known piston accumulator 1 in accordance with FIG. 2 has one piston 5, on which guide rings 7 and a supporting ring 8 for a seal 9 are mounted.

In contrast, a seal 9 without a supporting ring 8 is mounted on piston 5 in accordance with an embodiment of the present invention shown in FIG. 1. Seal 9 is designed as a sealing ring of elastomer. Seal 9 is accommodated in a circumferential groove 10 in piston 5 and rests sealingly against housing wall 4.

Piston 5 in accordance with FIG. 1 is fabricated of plastic. Slide layer 6 is directly formed on piston 5, namely it is integrated therein. In this context, slide layer 6 is formed in one piece and integrally with piston 5. Slide layer 6, in this embodiment, is the outer surface 11 of piston 5. The low friction properties of the plastic are thereby utilized without providing a slide layer 6 that is structurally or constructionally separate from piston 5. Piston 5 is fabricated of a thermoset plastic.

A compressible gas, preferably nitrogen, which may be compressed by a hydraulic fluid acting on piston surface 12, is accommodated in pressure chamber 3. When the gas is compressed, piston 5 travels along housing wall 4. In the process, piston 5 slides along housing wall 4.

Housing 2 has a cup-shaped form. It has an open end 13, into which piston 5 is inserted and secured by a retaining ring 15. At open end 13, a thread 14 is formed, which allows piston accumulator 1 to be screwed in place as a whole into an existing configuration. For example, piston accumulator 1 may be used as a pulsation damper in hydraulic systems of motor vehicles.

Piston accumulator 1 may also be used together with a mechatronics system which controls a pressure oil supply and/or automated transmissions.

With regard to other advantageous embodiments and refinements of the teaching of the present invention, reference is made, on the one hand, to the general portion of the Specification and, on the other hand, to the appended claims.

While the invention has been particularly shown and described with reference to preferred embodiments thereof, it will be understood by those skilled in the art that various changes in form and details may be made therein without departing from the spirit and scope of the invention.

1. A piston accumulator, comprising:
a housing including a housing wall;
a piston disposed in the housing, the housing wall and the piston forming a pressure chamber, the piston being slidably moveable along the housing wall so as to change a volume of the pressure chamber; and
a slide layer disposed on at least one of the piston and the housing wall and configured to guide the piston free of guide rings.

2. The piston accumulator as recited in claim 1, wherein the slide layer is disposed on the piston.

3. The piston accumulator as recited in claim 1, wherein the slide layer is disposed on the housing wall.

4. The piston accumulator as recited in claim 1, wherein the piston includes a seal free of a supporting ring.

5. The piston accumulator as recited in claim 1, wherein the piston is formed from a plastic.

6. The piston accumulator as recited in claim 5, wherein the slide layer is formed in one piece and is integral with the piston.

7. The piston according to claim 6, wherein the slide layer is an outer surface of the piston.

8. The piston accumulator as recited in claim 5, wherein the plastic of the piston is a thermoset plastic.

9. The piston accumulator as recited in claim 5, wherein the plastic of the piston is a thermoplastic plastic.

10. The piston accumulator according to claim 1, wherein the piston is formed from aluminum by a shaping process.

11. The piston accumulator according to claim 1, wherein the piston is formed from aluminum by a cold extrusion process.

12. The piston accumulator according to claim 1, wherein the housing is formed from a plastic.

13. The piston accumulator according to claim 12, wherein the plastic of the housing is a thermoset plastic.

14. The piston accumulator according to claim 12, wherein the plastic of the housing is a thermoplastic plastic.
